(19) United States
(12) Patent Application Publication
(10) Pub. No.: US 2008/0222313 A1
(43) Pub. Date: Sep. 11, 2008

(54) EMBEDDED INTERFACE

(76) Inventors: Paul L. Andrus, Turtle Lake, ND (US); Paul Alan Reber, Sherman, TX (US); Keith Scally, Sherman, TX (US)

Correspondence Address: CARSTENS & CAHOON, LLP, P O BOX 802334, DALLAS, TX, 75380, US

(21) Appl. No.: 12/050,012

(22) Filed: Mar. 17, 2008

Related U.S. Application Data
(63) Continuation-in-part of application No. 11/462,632, filed on Aug. 4, 2006, now Pat. No. 7,367,513.
Application No. 11/462,632 is a continuation of application No. 10/968,056, filed on Oct. 19, 2004, now Pat. No. 7,108,191.

(51) Int. Cl. G06F 3/00; G06F 13/12

(52) U.S. Cl. 710/10; 710/72

(57) ABSTRACT

The present invention provides a universal host-to-host intelligent controller that facilitates the transfer of electronic data from one electronic data processing (EDP) device to another. The invention includes a printed circuit board (PCB) contained in a housing and may also include a removable memory module. The PCB contains drivers and software code that automatically load and execute on said EDP devices when the PCB is connected to the EDP devices. The drivers and software code facilitate the direct transfer of data from storage on one EDP device to storage on the other EDP device. The controller includes at least two EDP connectors coupled to the PCB. These connectors can take the form of high-speed data cables and static PCB connectors as well as wireless antennae. The controller can also be incorporated into one or both EDP devices.

### CROSS-REFERENCE TO RELATED APPLICATIONS

The present invention is a continuation-in-part of and claims priority from pending U.S. patent application Ser. No. 11/462,632, entitled Intelligent Computer Cabling, filed on Aug. 4, 2006 which is a continuation of U.S. Pat. No. 7,108,191 entitled Intelligent Computer Cabling, filed on Oct. 19, 2004, the entire contents of each of which are incorporated by reference herein.

### TECHNICAL FIELD

The invention relates generally to the field of data transfer devices, which create a data link between two electronic data processing (EDPs) machines or devices using standard EDP interfaces. More specifically, the invention describes a cable based data transfer system with embedded code to automate the process of moving the data from one EDP to another using standard EDP connectivity interfaces.

### BACKGROUND OF THE INVENTION

There are numerous methods of transferring data from one electronic data processing machine (EDP) to another, including copying data to floppy disks, compact disks (CD), flash memory sticks or external data storage devices. There are also software programs and devices available to manage the data transfer using a cable or wireless connection using a standard parallel port, serial port, USB, PCMCI or other network (Ethernet or telephony) interface. These methods require the creation and management of a network.

Almost all of the above methods require manual installation and configuration of the device or the program managing the data transfer, except for the copy function of data to or from a data storage disk using a standard EDP read/write device such as a floppy disk drive (FDD).

The drawback with current cable and wireless methods is that the expertise required to install and configure the device and the related software application to manage the device and execute the desired data transfer is far beyond the expertise of the average computer user. In particular, these prior art data transfer systems lack a process to automate the loading, execution and configuration of the necessary code to facilitate the data transfer between two EDPs.

Therefore, it would be desirable to have an apparatus that automatically loads the drivers and code necessary to facilitate the transfer of data between EDP using standard EDP connectivity interfaces.

### SUMMARY OF THE INVENTION

The present invention provides a universal host-to-host intelligent controller that facilitates the transfer of electronic data from one electronic data processing (EDP) device to another. The invention includes a printed circuit board (PCB) contained in a housing and may also include a removable memory module. The PCB contains drivers and software code that automatically load and execute on said EDP devices when the PCB is connected to the EDP devices. The drivers and software code facilitate the direct transfer of data from storage on one EDP device to storage on the other EDP device. The controller includes at least two EDP connectors coupled to the PCB.

These connectors can take the form of high-speed data cables and static PCB connectors as well as wireless antennae. In one embodiment, the controller PCB is incorporated into a plug-type housing containing the connector on the end of a data cable. In a variant of this embodiment, the plug-housing has a connector port, allowing a legacy cable connector to plug into the plug housing containing the controller PCB. In another embodiment, the housing containing the controller PCB has a docking port for connection to a host EDP device PCB docking connector and an optional release lever. In yet another embodiment of the present invention, the controller is incorporated into one or both of the EDP devices.

Connection of the controller to the EDP devices automatically triggers the execution of the embedded software for auto loading of the necessary drivers and code to facilitate the transfer of the data directly from one EDP device to the other. The controller emulates a peripheral device attached to the EDP devices using the data storage capacity of the receiving EDP as the serial bus end-point. The functional result of the apparatus use is an easy-to-use true “plug and play” data transfer system through the emulation of the target EDP device as a peripheral storage device connected to the source EDP device.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 depicts a 3.5″ FDD compatible diskette in accordance with the present invention;

FIG. 2 shows two EDPs connected with a FDD compatible diskette assembly;

FIG. 3A shows the top side of the FDD diskette interface in accordance with the present invention;

FIG. 3B shows the bottom side of the FDD diskette;

FIG. 4 shows an example configuration of the inside of the FDD diskette;

FIG. 5 show the architecture of the cable-housing unit connected to the diskette at one end and a standard USB plug type A on the other end;

FIG. 6 shows the diskette of the present invention inserted into an EDP 201 through a standard 3.5″ FDD external interface;

FIG. 7 is a general flowchart of the auto-load process of the first embodiment of the present invention;

FIG. 8A shows an alternate embodiment of the present invention with USB plugs at both ends of the cable;

FIG. 8B shows an embodiment of the present invention with a USB plug at one end of the cable and an IEEE-1394 plug at the other end;

FIG. 8C shows an embodiment of the present invention with IEEE-1394 plugs at both ends of the cable;

FIG. 8D shows an embodiment of the present invention with FDD interfaces at both ends of the cable;

FIG. 8E shows an embodiment of the present invention with a FDD interface at one end of the cable and an IEEE-1394 plug at the other end;

FIG. 9 shows an embodiment of the present invention with an embedded universal host-to-host intelligent controller;

FIG. 10 shows an embodiment of the present invention with another embedded universal host-to-host intelligent controller;

FIG. 11 shows an embodiment of the present invention with an embedded wireless universal host-to-host intelligent controller;

FIG. 12 shows an embodiment of the present invention with the embedded wireless universal host-to-host intelligent controller;

FIG. 13 shows an embodiment of the present invention with the universal host-to-host intelligent controller with memory;

FIG. 14 shows an embodiment of the present invention with the universal host-to-host intelligent controller autorun autoload file transfer utility;

FIG. 15 shows an embodiment of the present invention with a wireless universal host-to-host intelligent controller with high-gain, high-quality detachable omni-directional radio frequency antenna;

FIG. 16 shows an embodiment of the present invention with the universal host-to-host intelligent controller with removable memory;

FIG. 17 shows an embodiment of the present invention with the universal host-to-host intelligent controller molded into a plug-type housing;

FIG. 18 shows an embodiment of the present invention with another universal host-to-host intelligent controller with removable memory;

FIG. 19 shows an embodiment of the present invention with the universal host-to-host intelligent controller molded into a plug-type housing;

FIG. 20 shows an embodiment of the present invention with another universal host-to-host intelligent controller with removable memory

FIG. 21 shows an embodiment of the present invention with a static universal host-to-host intelligent controller; and

FIG. 22 shows an embodiment of the present invention with a static universal host-to-host intelligent controller PCB.

### DETAILED DESCRIPTION OF THE DRAWINGS

The present invention provides a cable based data transfer apparatus that contains embedded electronics using flash memory to automatically load the drivers and code to facilitate the transfer of data utilizing standard electronic data processing (EDP) connectivity interfaces.

Universal serial bus (USB) interfaces are becoming the de facto interface standard for connectivity to peripheral devices and is currently included in the manufacturing of new EDPs. USB specifications provide built-in functionality to make peripheral expansion more user friendly as well as providing a single cable model for connectivity to an EDP. These features include self-identification of USB compliant peripherals, auto mapping of functions to a driver and enabling a peripheral device to be dynamically attachable and re-configurable. The USB specification also includes a data flow model, which provides the architecture to manage data transfer from a host platform to an end-point on a device (pipe). The USB Specification provides requirements for the electrical and physical connection between the peripheral device and the host using the bus. An important feature of the USB interface is that it provides up to 500 milliamps of electrical power at 5 volts and signals very fast at 480 Mb/s for high speed USB devices compared to 115 kbits/s for serial and parallel port interfaces.

For the transfer of data from one EDP to another using the USB specification, cables are typically used as the transport medium between a standard USB port on an EDP (connector type A) and a USB compatible peripheral device (connector type B) or another USB port on another EDP. Using the USB specification to transfer data from one EDP to another requires the creation or emulation of a peripheral type device to utilize the embedded USB functionality. This is typically accomplished by loading and configuring a software application that in turn loads the appropriate drivers and provides the necessary code to create the USB end-point and manage what has become a cable based peripheral. This process normally involves loading a compact disk in the CD drive and loading and configuring the necessary application and/or code, which requires considerable expertise on the user's part.

Like USB, IEEE-1394 is an external bus standard that uses twisted pair wiring to move data. It also supplies an electric current along with support for Plug-and-play or “hot plugging” with compatible peripheral devices. The basic feature/functionality sought in the development of this standard is the same as USB, mainly to replace the myriad of I/O connectors employed by consumer electronics equipment and personal computers. Like USB, it supports the concept of an isochronous device, a device that needs a certain amount of bandwidth for streaming data. IEEE-1394 is considered a high performance serial bus in that it supports data transfer rates substantially higher than current USB specifications. It has two forms, 1394a and 1394b with the later supporting transfer rates of 800 Mbps, twice that of 1394a.

IEEE-1394 is a layered transport system. The current standard defines three layers: Physical, Link and Transaction. The Physical layer provides the signals required by the IEEE-1394 bus. The Link layer takes the raw data from the Physical layer and formats it into recognizable 1394 packets. The Transaction layer takes the packets from the Link layer and presents them to the application.

Because of its high data transfer rates and multiplexing capabilities of a variety of different types of digital signals, IEEE-1394 is being adopted as the de facto standard for the transfer of large data volumes, particularly those devices that require real-time transfer of high levels of data such as compressed video and digitized audio. IEEE-1394 interfaces are beginning to be included in the manufacturing of personal EDP machines.

Floppy disk drives (FDDs) have been included in the manufacturing of most EDPs to date. The current standard for an EDP is an FDD that utilizes a 3.5″ floppy magnetic disk. The important feature of a standard FDD relative to this invention is the read/write head, which is used to convert binary data to electromagnetic pulses when writing to the disk, and the reverse when reading from the disk. However, FDDs are being phased out as part of the normal technology life cycle for computer disk drives due to the adoption of the compact disk (CD) and digital versatile disk (DVD).

FDDs are typically used for loading new software applications onto to the memory of the EDP or for extracting data to a floppy disk for storage or data transfer. FDDs are also typically used to create “boot disks” for the EDP's operating system. One of the major drawbacks of FDDs leading to its obsolescence is the limitation of the amount of data that can be stored on a standard floppy disk as well as the slow transfer rates.

Elements exist that can interface with the standard read/write heads of most FDDs using a smart-diskette. This creates a physical transfer interface using a basic magnetic transducer that is essentially a simple antenna-based transmitter and receiver of the electromagnetic pulses created by the FDD's read/write heads. However, these elements lack an automated process and transfer medium for transferring data from one EDP to another. Such smart-diskette based technologies are primarily used to provide an interface for smart cards (e.g., medical patient smart-cards and various peripheral memory cards) to the host EDP through the FDD read/write head mechanism. There are also a number of other drawbacks to current smart-diskette technologies including the requirement for a voltage generator and/or batteries to provide the necessary electrical current to run the necessary processors and controllers and the lack of an interface to any of the current standard EDP interfaces including the USB specification. Other disadvantages include the requirement for loading and configuring a software application prior to usage and the lack of an automated method to self-discover a peripheral plugged into a smart-diskette interface or plug.

Flash-memory using programmable gate array based memory modules is a relatively new type of solid-state technology. This type of electronic non-volatile memory chip can also be erasable. Inside the flash memory chip is a grid of columns and rows, with a two-transistor cell at each intersecting point on the grid. A thin oxide layer separates the two transistors. One of the transistors is known as the floating gate, and the other one is the control gate. The electrons in the cells of a flash-memory chip can be manipulated by the application of an electric field, a higher-voltage charge. Flash-memory uses in-circuit wiring to apply this electric field either to the entire chip or to predetermined sections known as blocks. These blocks can be programmed or erased and re-written. Flash memory works much faster than traditional electrically erasable programmable read-only memory (EEPROM) chips because instead of erasing one byte at a time, flash memory erases a block or the entire chip.

Peripheral devices containing flash memory modules have the advantage of being relatively inexpensive and require relatively little power as compared to traditional magnetic storage disks. Most devices containing flash memory connect to the host EDP using one of the standard EDP interfaces (e.g., USB, PCMCIA, etc.) and then use the low cost chips to either provide a self-contained data storage medium or send a driver to the host EDP and rely on a separately loaded software application to manage the device.

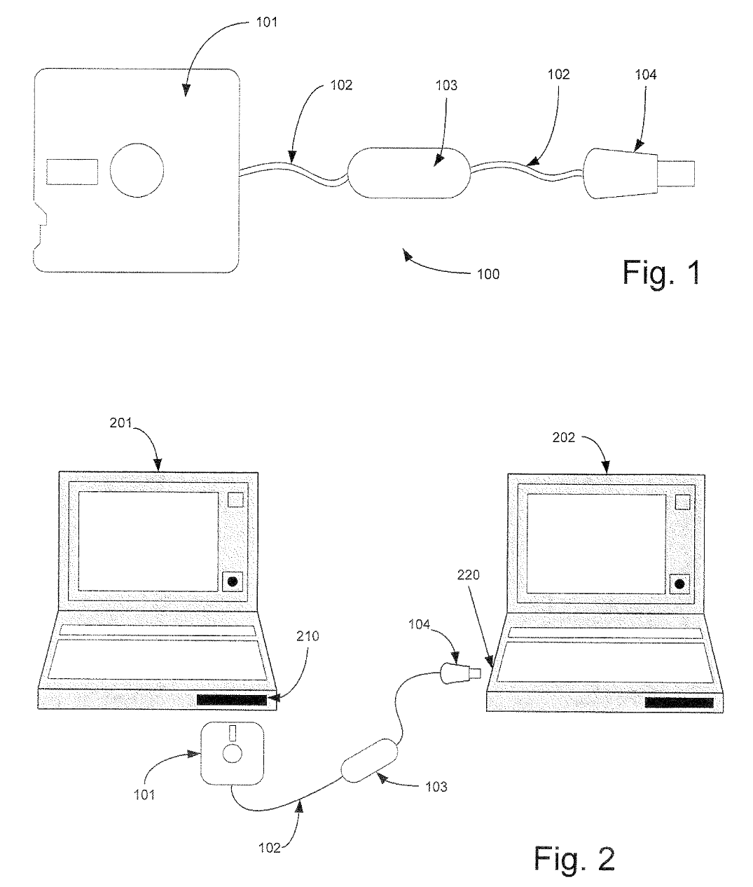

With reference now to the figures, FIG. 1 depicts a 3.5″ FDD compatible diskette in accordance with the present invention. In this embodiment of the invention, the data transfer apparatus 100 comprises a 3.5″ FDD compatible diskette 101 containing electronic components connected to a twisted pair cable 102 that is in turn connected to a cable housing unit 103. The cable housing unit 103 contains additional electronic components mounted on a solid-state board/card and is connected by the twisted pair cable 102 to a USB type A plug 104.

FIG. 2 shows two EDPs connected by a FDD compatible diskette assembly. The diskette 101 is inserted into the 3.5″ FDD 210 of the first EDP 201, and the USB plug 104 is inserted into the USB port interface 220 of the second EDP 202. The USB interface, through existing USB specifications and functionality provided with EDP 202, provides an electrical current to the apparatus 100. Electrical current is also provided by the twisted pair cable 102 to the diskette 101 to power its electronic components.

When the data transfer apparatus 100 is plugged into the port interface 220 in the second EDP 202, USB interfaces auto-generate a request signal from the EDP 202. The processor and flash memory contained in the cable housing unit 103 answers the request from the EDP 202 with a reply that loads the necessary driver(s) and identifies the apparatus 100 as a peripheral storage type device and displays a drive letter and identifier in the EDP operating system's (OS) user interface. The processor in the cable-housing unit 103 then sends a storage file folder to the OS file structure and displays it in the user interface of the OS of EDP 202.

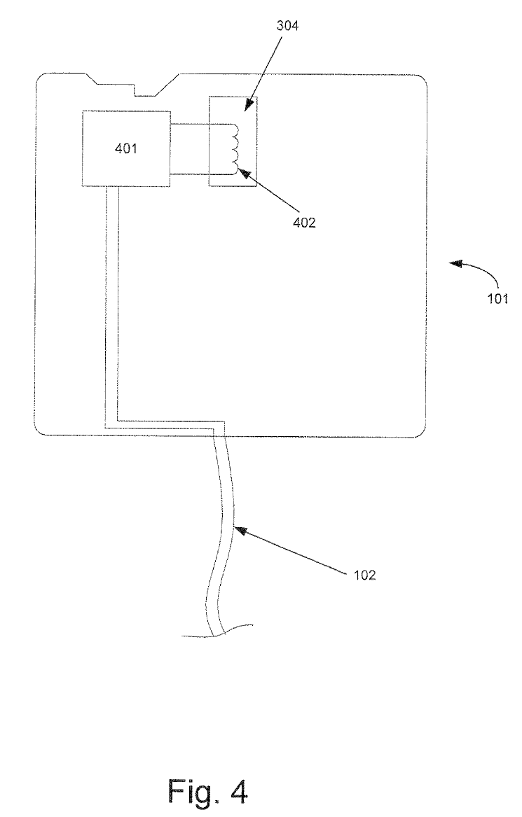

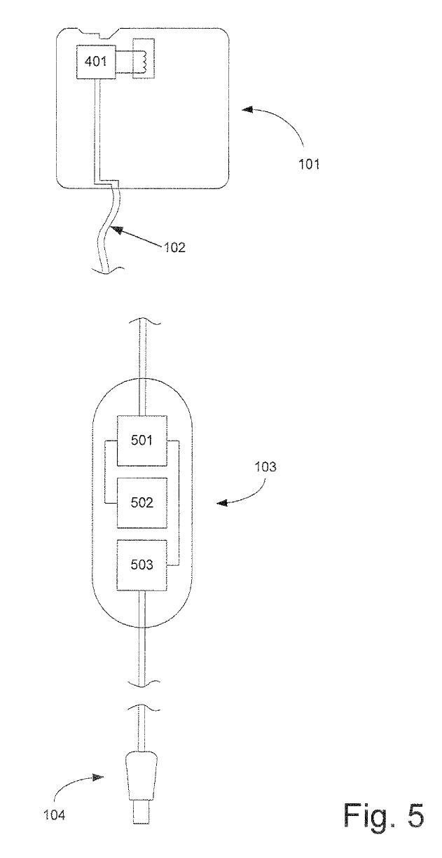

Simultaneous to the auto-loading of driver(s) and code to EDP 202, the processor and flash memory in cable housing unit 103 signals the controller 303 in the diskette 101 (shown in FIG. 4) to initiate the auto load process of drive selection, head alignment to track 00, and setting of the transfer rate with the FDD 210 of the first EDP 201. The processor in the cable housing unit 103 then sends a storage file folder to the OS file structure of EDP 201 through the twisted pair cable 102 and the electronic components in the diskette 101 and displays the file in the OS user interface of EDP 201.

The transfer of data from the first EDP 201 to the second EDP 202 is accomplished by simply copying the desired data to the appropriate FDD drive letter (usually Drive A:) through the default OS user interface resident on EDP 201. The data flow is regulated by the FDD 210 internal to EDP 201 and controller 303 in diskette 101 to move through the twisted pair cable 102 into the electronic components in cable housing unit 103 and then through twisted pair cable 102 and USB plug 104 into USB port interface 220 in EDP 202. The USB controller in housing unit 103 manages the flow of the data to EDP 202, directing it to the loaded file folder.

Transfer rates are dependent on the form implemented including the length and quality of twisted pair cable 102, its insulation/sheathing qualities, processing speeds of EDP internal processing chips, electrical current strength from USB port 220, as well as electronic component configurations and module types in cable housing unit 103 and diskette 101.

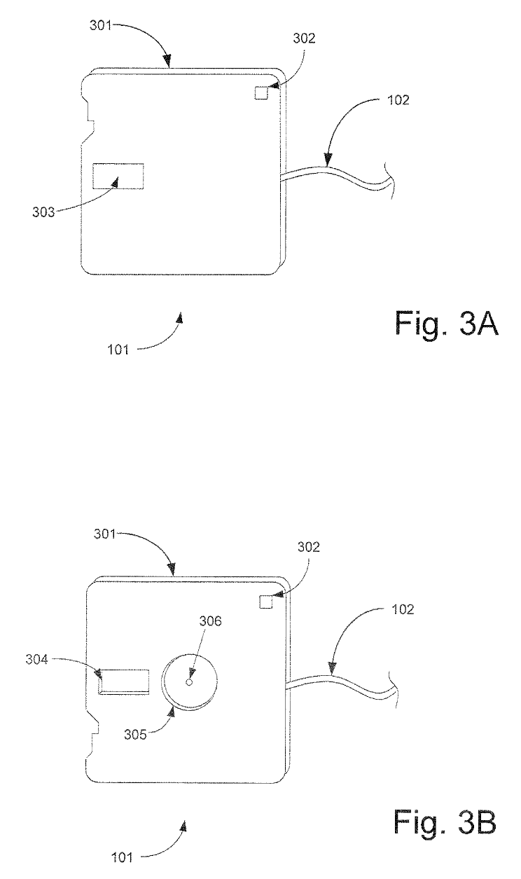

With reference now to FIG. 3A, the top side of the diskette 101 is depicted in accordance with the present invention. The diskette 101 is comprised of an outer casing 301 protecting the electronic components and wiring, which are contained inside the diskette and mounted on a solid-state circuit-type card wired to the twisted pair cable 102. The diskette 101 is approximately the same width (maybe slightly wider) and length of a standard 3.5″ floppy disk. The positioning of the attachment of twisted pair cable 102 can vary depending on the form of the configuration of the inner electronic components and wiring of the inside circuitry board of the diskette.

The write-protect window 302 is the same size and shape and in the same position as write-protect windows found on standard 3.5″ floppy disks. The write-protect window 302 is in the open position and contains no moving window or slider so that the diskette emulates a write-ready floppy disk.

The outer casing 301 of diskette 101 also has a cutout 303 on the top of the diskette exposing the inside of the diskette casing. Cutout 303 provides an area where the top read/write head rests while the diskette 101 is in the inserted position inside the FDD.

FIG. 3B depicts the bottom side of the diskette. A recess 304 accommodates and aligns the bottom read/write head of the FDD. In the center of the diskette 101 there is a circular recess 305 where the drive for a magnetic floppy disk would normally be, with another smaller and deeper circular recess 306 in the center to accommodate the drive spindle of the FDD. The positioning, shape and size of recesses 305, 306 is the same as found on standard 3.5″ floppy disks.

FIG. 4 shows an example configuration of the inside of diskette 101 in accordance with the present invention. Twisted pair cable 102 is wired to a circuitry-type board, which connects the twisted pair wires to the controller 401. Controller 401 manages the data flow to and from the cable housing unit through twisted pair wires 102. The controller 401 also controls data flow to and from the FDD by means of an electrically connected magnetic transducer 402 that receives and sends the signal pulses to and from the read/write head of the FDD. The read/write head sits in recess 304 to align the head on the diskette 101 so that an emulation of a 3.5″ floppy disk set at track 00 can be accomplished using the magnetic transducer 402 as an antenna-type receiver/transmitter of the electromagnetic pulse signals.

FIG. 5 shows the architecture of the cable-housing unit connected to the diskette at one end and a standard USB plug type A on the other end. The cable-housing unit 103 contains a solid-state circuit-type board/card configuration holding a microprocessor 501, memory (flash-type) 502 and a USB controller 503 along with wiring connecting the board and electrical components to the twisted pair cable 102. Processor 501 is connected to the circuitry-type board allowing it to send and receive signals to and from the diskette controller 401 and USB controller 503 as well as receive electrical current from the USB port interface on the EDP. The flash memory 502 module is a floating gate array type module containing all the code necessary to perform the execution of the application loads and driver installations upon system initialization when the apparatus is inserted into the first and second EDPs. The USB controller 503 manages the data flow and interaction with the second EDP using standard USB specifications and functionality, as described above.

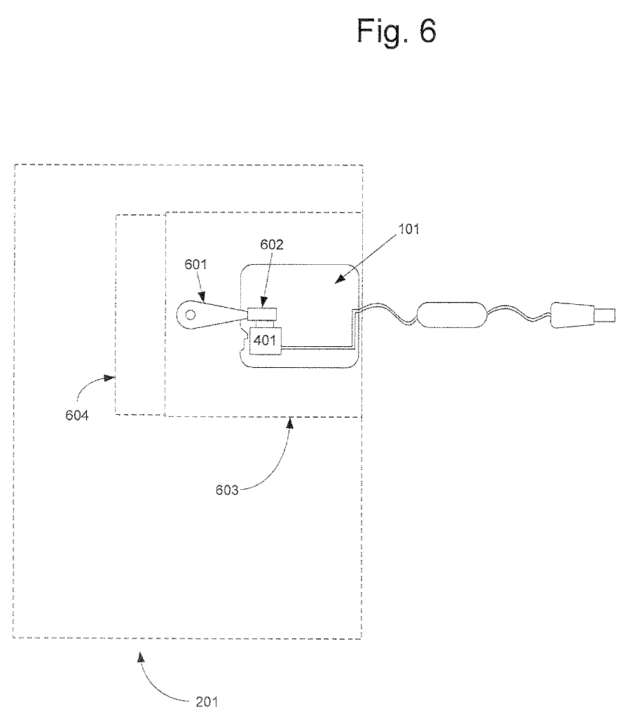

FIG. 6 shows the diskette 101 of the present invention inserted into an EDP 201 through a standard 3.5″ FDD external interface. The internal interface is depicted by showing diskette 101 in the inserted position and the FDD top arm assembly 601 holding read/write head 602 resting in recess of the diskette. Internal control of the FDD 603 is provided by the disk controller 604, which manages the data transfer internally between the FDD 603 and the internal processor and memory components of the EDP 201. These components are found with most all FDD devices.

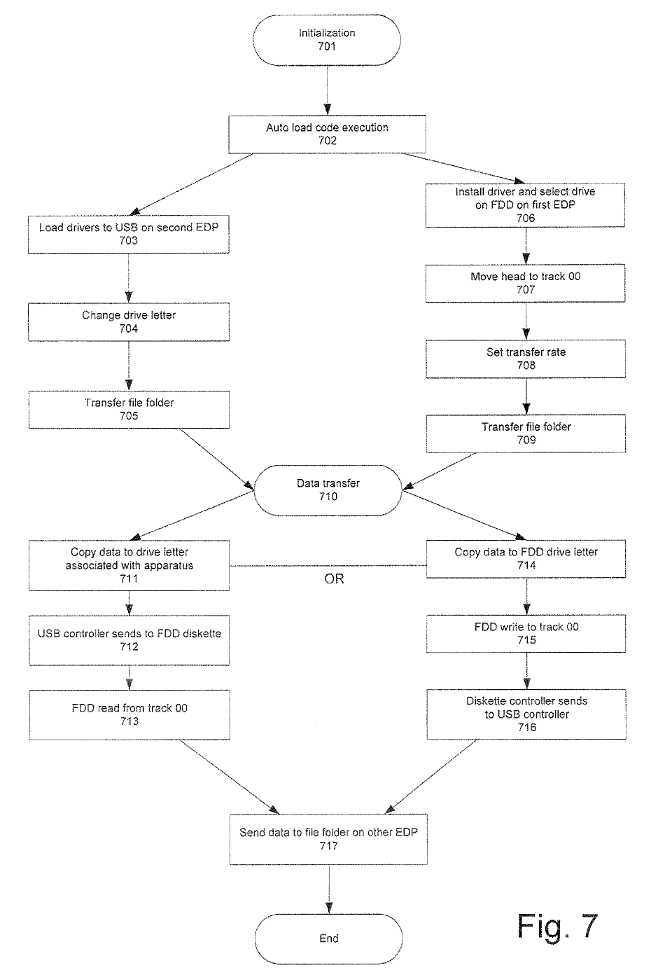

FIG. 7 is a general flowchart of the auto-load process of the present invention. The process is achieved by executing software code embedded in the memory of the apparatus contained in cable housing unit. The process begins with insertion of the diskette into the FDD interface of the first EDP and insertion of the USB plug into the USB port interface of the second EDP, which activates the initialization of the auto load process (step 701). The USB port interface provides the electrical current to the apparatus to power the processor and other electronic components contained in the cable housing unit and diskette. Software code execution then launches two parallel processes of loading the necessary file(s), driver(s) and code to each EDP (step 702).

The first process stream begins by answering the request generated by the second EDP and sending a response and the necessary driver(s) identifying the apparatus as a peripheral device (step 703). The auto-loading of the driver(s) creates a drive letter displayed in the OS user interface of the EDP identifying the apparatus as a peripheral device (step 704). The apparatus then transfers a file folder to the file structure of the EDP OS and displays it as a file related to the data transfer system apparatus (step 705).

The second process stream begins by installing a driver on the first EDP and sending a signal to the FDD identifying the diskette as a drive, using the default OS identifier for the FDD (normally displayed as drive A: in most operating systems) (step 706). The apparatus then sends a signal to the FDD disk controller to move the read/write head to track 00 (step 707). The diskette controller accommodates the emulation of the diskette as a floppy disk with track 00. The data transfer rate is set in the same manner of sending a signal managed by the controller through the magnetic transducer to the read/write head of the FDD (step 708). The apparatus then auto transfers a file folder to the file structure of the first EDP OS and displays it as a file related to the data transfer system apparatus (step 709).

The data transfer process can now begin on each EDP by using the existing OS user interface of each machine to copy and move the files from one machine to another (step 710).

To copy data from the second EDP to the first, the user copies the data to the drive letter (i.e. A:) that identifies the drive as the apparatus (step 711). The copy procedure is the same procedure already used by the user to copy data and files from one location to another using the character based command line user interface or the graphical user interface (GUI) provided by the EDP's OS. When the copy function is completed, the USB controller sends the data to the cable-housing unit, which passes the data to diskette controller, and the diskette controller then sends the data as signals to the read/write head as an emulation of track 00 on a floppy disk (step 712). The FDD of the first EDP reads from track 00 (step 713) and sends the data to the file folder that was sent to the first EDP in step 709 earlier in the auto load process (step 717).

Transfer of data from the first EDP to the second is essentially the reverse of steps 711-713. The process begins by copying the desired data from the first EDP to the FDD drive letter (step 714). Again, the copy procedure is the same procedure typically used to copy data and files from one location to another. When the copy function is completed, the FDD disk controller writes the data to track 00 (step 715), which is then picked up by the magnetic transducer and sent by the diskette controller to the USB controller through the cable-housing unit (step 716). The data transfer process is completed by the USB controller sending the data through the USB port interface to the file folder on the second EDP (step 717).

In both copy processes, the users of the EDPs use the existing user interfaces of their respective machines provided by the operating systems. The default copy, move, and erase procedures are also followed to move the transferred data from the storage file folder placed in the EDPs' file structure in step 704 and 709 to the desired location on the EDPs. Using the present invention, the data volume that can be transferred from one EDP to another is limited only by the total available data storage capacity of the EDP receiving the transferred data.

In addition to the example embodiment described above employing 3.5″ FDD and USB interfaces, the present invention may also be implemented with the IEEE-1394 standard. By incorporating the FDD, USB and IEEE-1394 interfaces, the present invention is capable of five alternate embodiments in addition to the one described above.

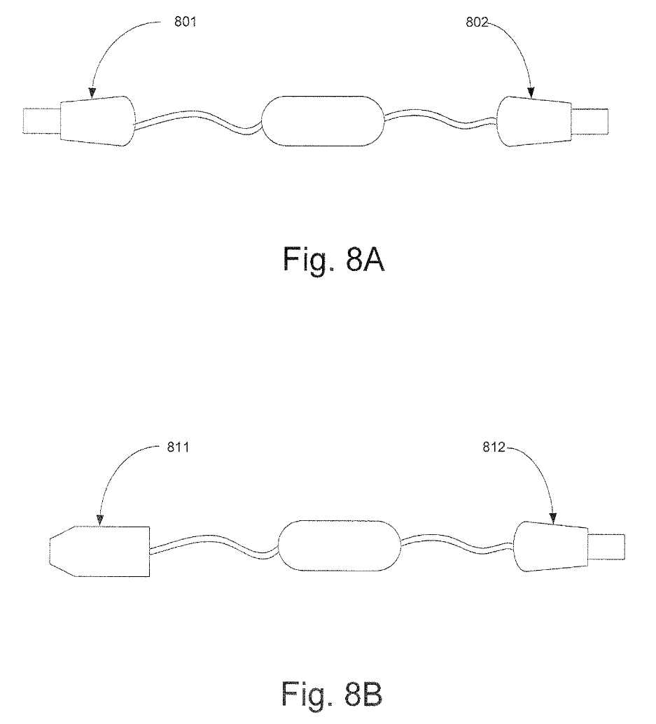

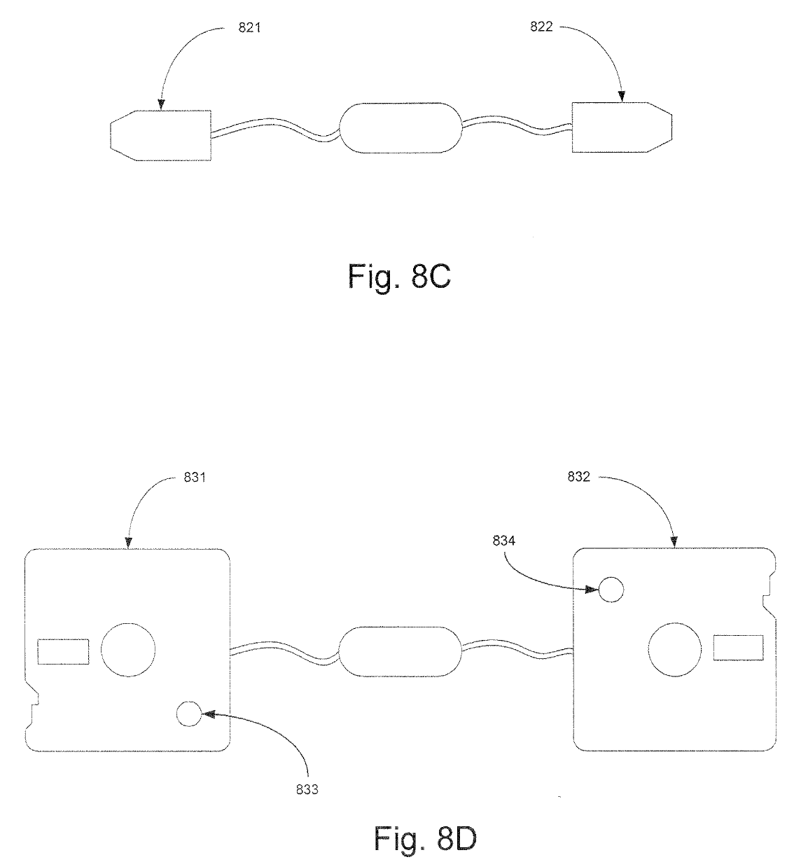

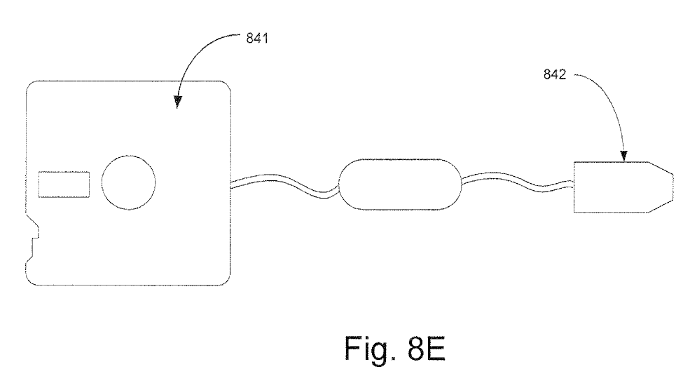

FIG. 8A shows an alternate embodiment of the present invention with USB plugs 801, 802 at both ends of the cable.

FIG. 8B shows an embodiment of the present invention with a USB plug 811 at one end of the cable and an IEEE-1394 plug 812 at the other end.

FIG. 8C shows an embodiment of the present invention with IEEE-1394 plugs 821, 822 at both ends of the cable.

FIG. 8D shows an embodiment of the present invention with FDD interfaces 831, 832 at both ends of the cable using a battery 833, 834 inserted into each diskette to provide the necessary current to power the controller.

FIG. 8E shows an embodiment of the present invention with a FDD interface 841 at one end of the cable and an IEEE-1394 plug 842 at the other end.

The USB and IEEE-1394 interfaces provide almost identical feature/functionality in terms of issuing and handling requests from a peripheral device. (The invention apparatus is emulating a peripheral storage device.) USB and IEEE-1394 specifications are managed by separate governing bodies but the way in which the invention sends and receives data using the cable-based system is the same. The embodiments that include an FDD interfaces are more complicated than the USB and IEEE-1394 ones in that additional electronics are required to transfer, manage and control the data through the read/write head of the FDD. However, because the additional electronics are contained inside the diskette unit itself a single cable-housing unit can be manufactured to support all six embodiments. In this way, only the interface plugs/devices at the end of the cable change, which significantly reduces the cost to manufacture multiple products that have the same end function and user experience.

The present invention also includes a number of alternate embodiments that cover different data transfer processes between one or more devices.

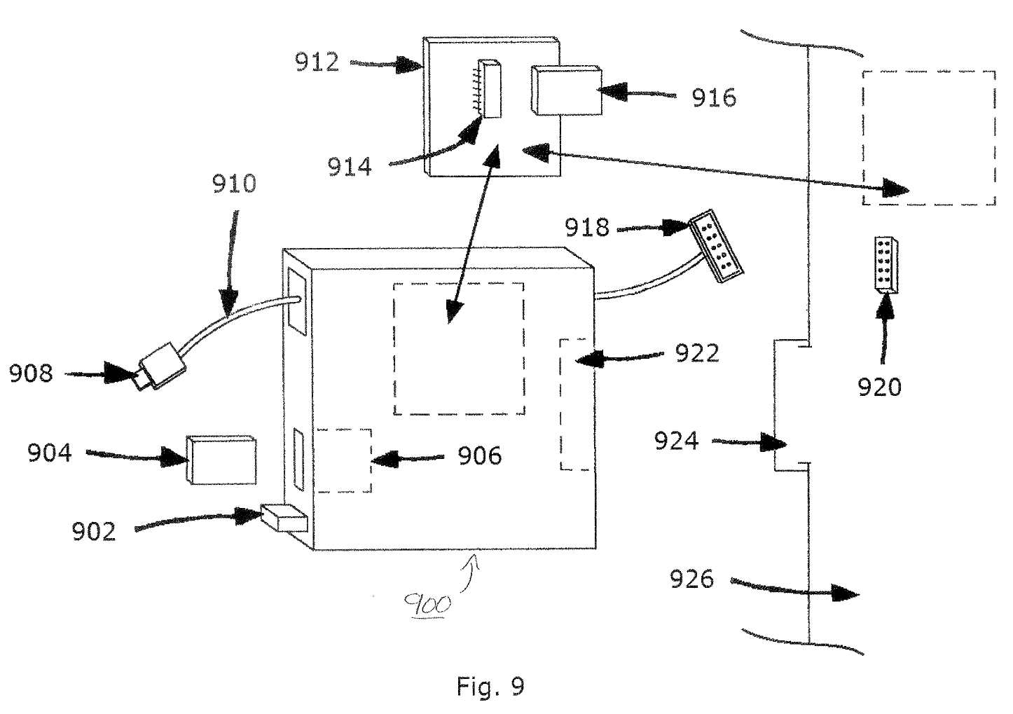

Referring now to FIG. 9, the architecture of an embedded universal host-to-host intelligent controller is depicted in accordance with an alternate embodiment of the present invention. The housing 900 includes a connector release lever 902, as well as a removable memory 904 with a corresponding connection slot 906. The release lever 902 and the removable memory 904 are optional. Like the other embodiments, this embodiment also includes a retractable high-speed data connector 908 and a retractable high-speed data cable 910. This embodiment also includes a static high-speed data cable with a PCB connector 918 for connection to a host EDP PCB connector 920 on the host EDP PCB 926.

The system may optionally include a removable onboard memory 912 which includes a connector 914 and memory module 916.

The embedded universal host-to-host intelligent controller also includes a docking port 922 for connection to a host EDP PCB docking connector 924. The embedded universal host-to-host intelligent controller may connect to the host EDP PCB 926 by either the static high-speed cable connector 918 or the docking connector 922 depending on the configuration of the host system in question. The controller housing 900 is ejectable from the host EDP PCB 926 to facilitate repair, replacement or upgrades. An embedded universal host-to-host intelligent controller with a removable onboard memory PCB 912 may appear in the retractable cable mechanism housing 900 or on a host EDP PCB 926.

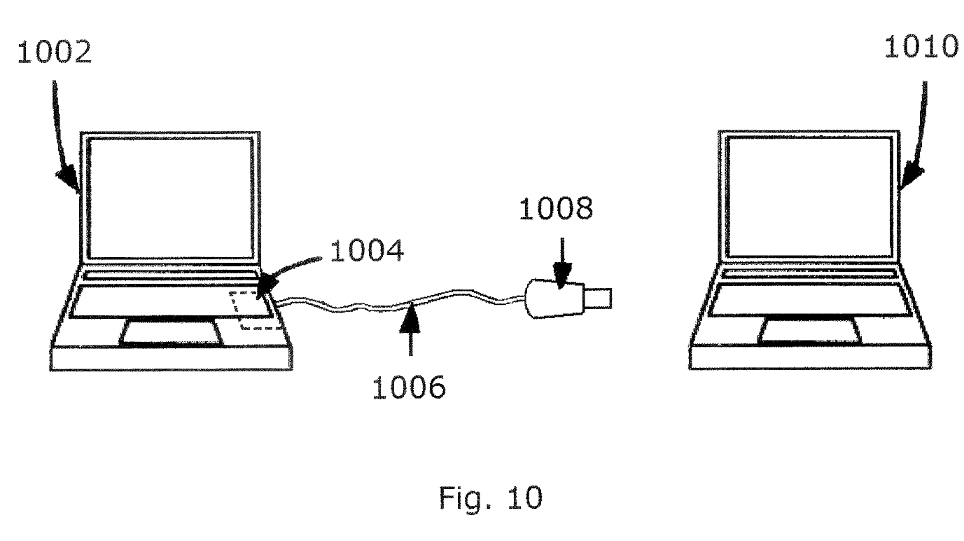

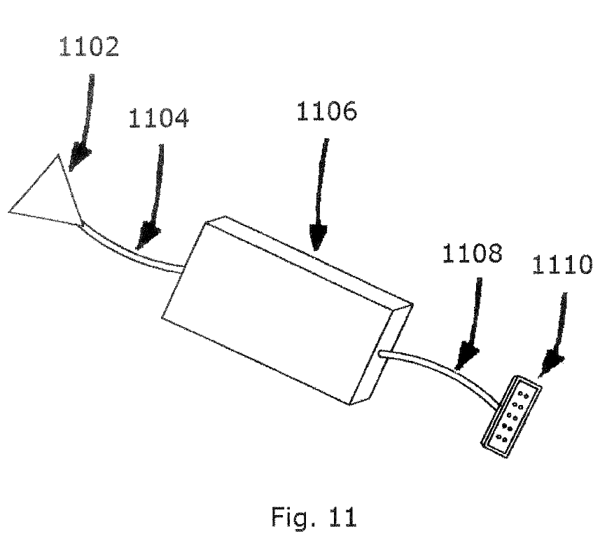

Referring now to FIG. 10, a host EDP 1002 includes a module 1004 that includes an embedded universal host-to-host intelligent controller with removable onboard memory. In one embodiment, the controller module 1004 is removable from the host EDP 1002. The example depicted in FIG. 10 shows a retractable high-speed data cable 1006 with cable connector 1008 for connection to a second host EDP 1010. The second host EDP 1010 may also have its own embedded host-to-host intelligent controller.

FIG. 11 depicts a wireless embodiment of the present invention. In this embodiment, the embedded wireless universal host-to-host intelligent controller 1106 includes a high-gain, high-quality omni-directional radio frequency antenna 1102 and a low-loss radio frequency coaxial transmission line 1104 that couples the antenna 1102 to the controller 1106. The controller is also coupled to a high-speed data cable 1108 with a PCB connector 1110.

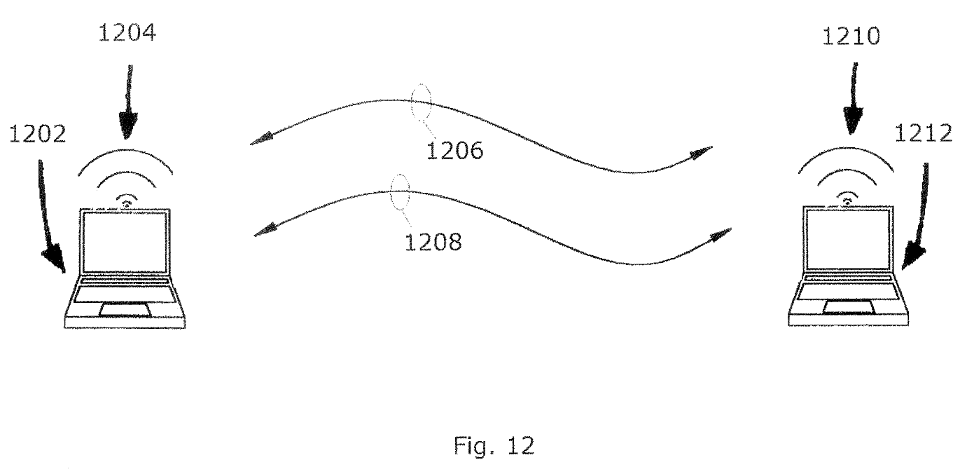

FIG. 12 depicts a fully wireless data transfer system in accordance with an alternate embodiment of the present invention. This embodiment includes the same universal host-to-host intelligent controller as the other embodiments described above but replaces the wired data cables and connectors with wireless antennae.

In the example shown in FIG. 12 the first host EDP 1202 includes a first embedded wireless universal host-to-host intelligent controller with high-gain, high-quality omni-directional radio frequency antenna 1204 and a low-loss radio frequency coaxial transmission line and high-speed data cable with PCB connector (not shown) housed within the EDP. The second host EDP 1212 also includes an embedded wireless universal host-to-host intelligent controller with high-gain, high-quality omni-directional radio frequency antenna 1210 and a low-loss RF coaxial transmission line and high-speed data cable with PCB connector. The EDPs 1202 and 1212 communicate with one another via at least one of an omni-directional radio frequency data channel transmission path 1206 and an omni-directional radio frequency control channel transmission path 1208.

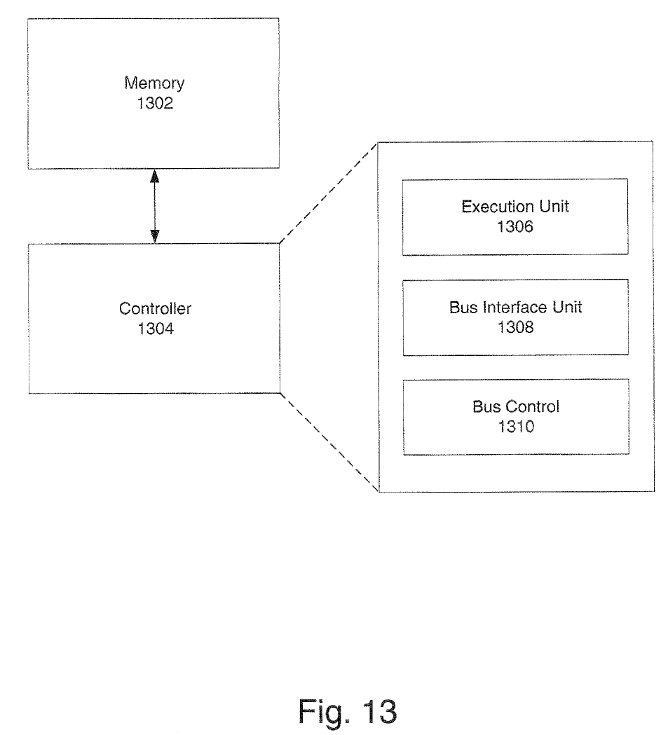

FIG. 13 is a block diagram of the universal host-to-host intelligent controller in accordance with the present invention. The controller 1304 is depicted with an accompanying memory module 1302. The controller 1304 is comprised of a number of elements including an execution unit (EU) 1306, a bus interface unit (BIU) 1308, and a bus control (BC) 1310.

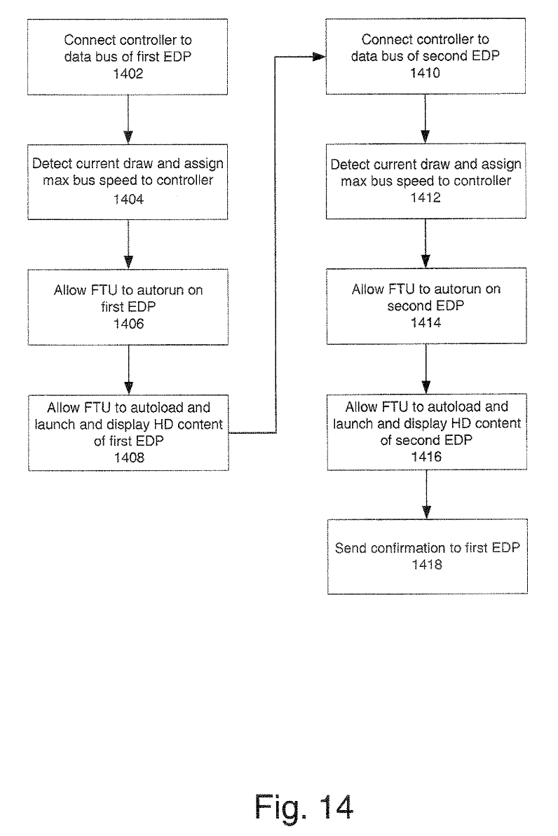

FIG. 14 is a flowchart illustrating the autorun, autoload File Transfer Utility (FTU) sequence used by the universal host-to-host intelligent controller in accordance with the present invention. The process begins by connecting the universal host-to-host intelligent controller to the first EDP device data bus, whereby the controller detects power (step 1402). The first host EDP device detects the amount of current drawn by the universal host-to-host intelligent controller on the data bus and assigns the controller a maximum data bus speed (step 1404).

The first host EDP device reads the product information set from the universal host-to-host intelligent controller memory and allows the controller FTU software executable to autorun (step 1406). The first host EDP device then allows the controller FTU software executable to autoload, and the FTU launches on the first EDP and displays the hard drive contents of the first EDP device on the FTU (step 1408).

The universal host-to-host intelligent controller is then connected to the second EDP device data bus, whereby the controller detects power (step 1410). As with the first EDP device, the second host EDP device detects the amount of current drawn by the universal host-to-host intelligent controller on the data bus, and the second host EDP device assigns a maximum data bus speed to the controller (step 1412). The second host EDP device reads the product information set from the universal host-to-host intelligent controller memory and allows the controller FTU software executable to autorun (step 1414). The second host EDP device then allows the controller FTU software executable to autoload and the FTU launches on the second EDP device and displays the hard drive contents of the second EDP device (step 1416).

Finally, the first EDP device is sent confirmation that the second EDP device is successfully connected and both first EDP and second EDP devices are networked, wherein the FTU on each device is able to display the hard drive contents of both EDP devices (step 1418).

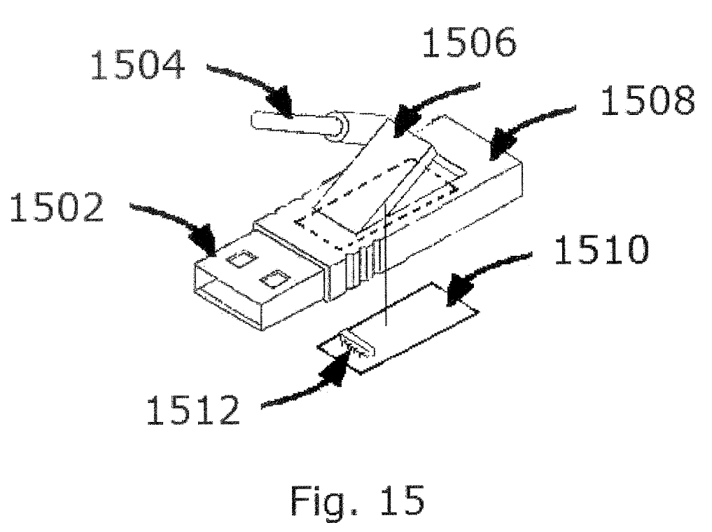

FIG. 15 depicts an intelligent connector (IC) in accordance with the present invention. This particular connector provides wireless capability for data transfer. The connector includes a high-speed data connector 1502 and a high-gain, high-quality detachable omni-directional radio frequency antenna 1504. As an option, the connector may also include a removable memory 1506. In this embodiment, the molded, plug-type housing 1508 contains a wireless universal host-to-host intelligent controller PCB 1510 and removable memory PCB connector 1512, rather than the controller being located in the cable housing. In the preferred embodiment, the high-speed data connector 1502 is preferably molded into the plug-type housing 1508.

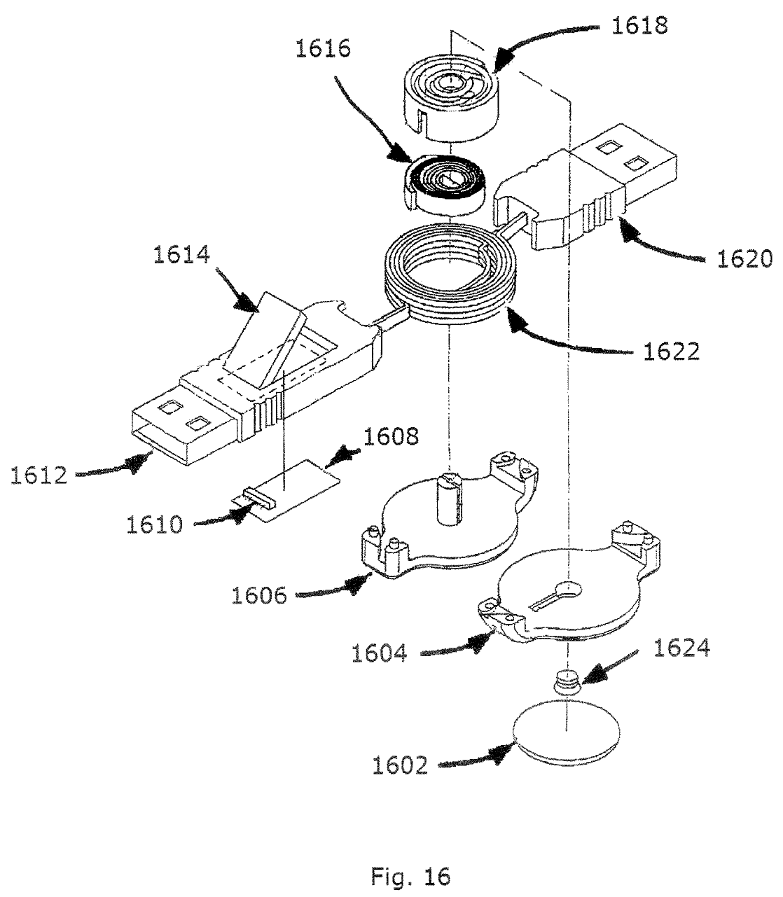

FIG. 16 illustrates an exploded view of a universal host-to-host intelligent controller in accordance with the present invention. The controller includes a cosmetic cover 1602, a lower cable spool housing 1604 and an upper cable spool housing 1606 that fit together as shown by the broken lines and secured by a retaining screw 1624. The first high-speed data connector 1612 contains the universal host-to-host intelligent controller PCB 1608 and removable memory PCB connector 1610. The connector 1612 may optionally include a removable memory module 1614 as well.

The first connector 1612 is connected to the second high-speed data connector 1620 by a coiled high-speed data cable 1622 which runs through the center cable spool housing. In the center of the cable spool housing is a retractable cable mechanism spring 1616 and cam 1618 which fit around the post of the upper cable spool housing 1606 and secured by the retaining screw 1624.

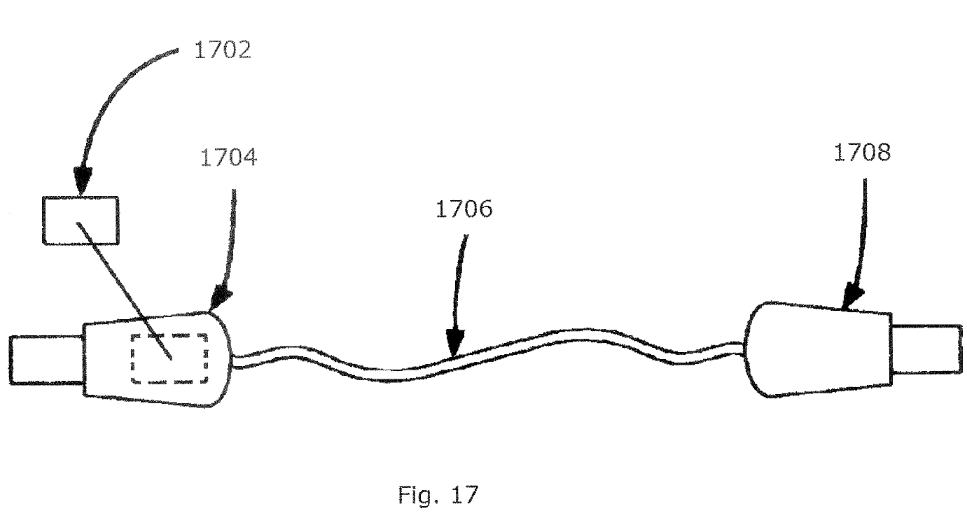

FIG. 17 shows an alternate embodiment of the present invention. In this embodiment, the universal host-to-host intelligent controller is molded into a plug-type housing. More specifically, the controller includes a universal host-to-host intelligent controller PCB 1702 molded into a first high-speed connector housing 1704, a high-speed data cable 1706, and a second high-speed connector housing 1708. The example depicted does not include a retractable cable housing, however this may be included depending on the length of the data cable 1706.

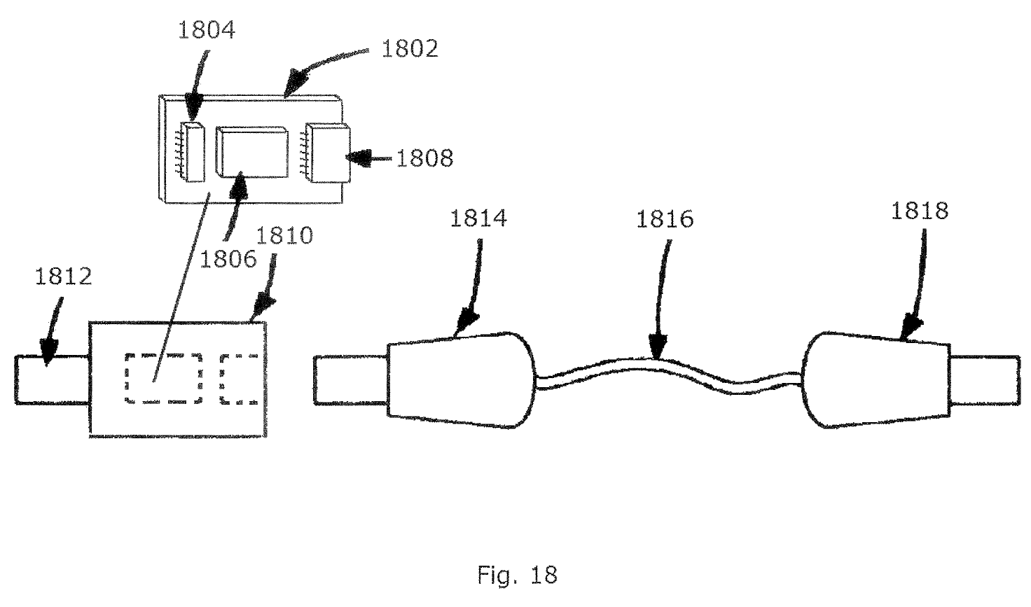

FIG. 18 shows an intelligent connector (IC) that can be retrofitted to existing data cables in accordance with an alternate embodiment of the present invention. In this embodiment, the controller PCB 1802 is housed in or on a molded plug-type housing 1810 which includes a high-speed data connector 1812. The controller includes a universal host-to-host intelligent controller PCB 1802 which includes a removable memory PCB connector 1804, an optional removable memory 1806, and a second high-speed data connector 1808.

The second data connector 1808 is a plug port that allows a third high-speed data connector 1814 to plug into the housing 1810 containing the controller. The third connector 1814 is in turn connected to a fourth data connector 1818 via a high-speed data cable 1816. As such, this embodiment allows the data transfer functions of the present invention to be retrofitted to pre-existing conventional data cables.

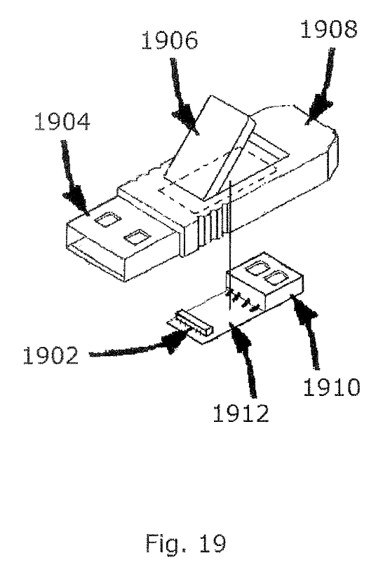

FIG. 19 shows a retrofit intelligent connector (IC) similar to the one depicted in FIG. 18. Like the other embodiments this embodiment includes a first high-speed data connector 1904 and a molded, plug-type housing 1908. The controller includes a universal host-to-host intelligent controller PCB 1912 and an optional removable memory PCB connector 1902. This embodiment may optionally include a separate removable memory 1906 that fits into the opposite side of the housing as shown in FIG. 19. The intelligent controller PCB 1912 includes a high-speed data connector port 1910 that allows legacy data cables to connect with the controller.

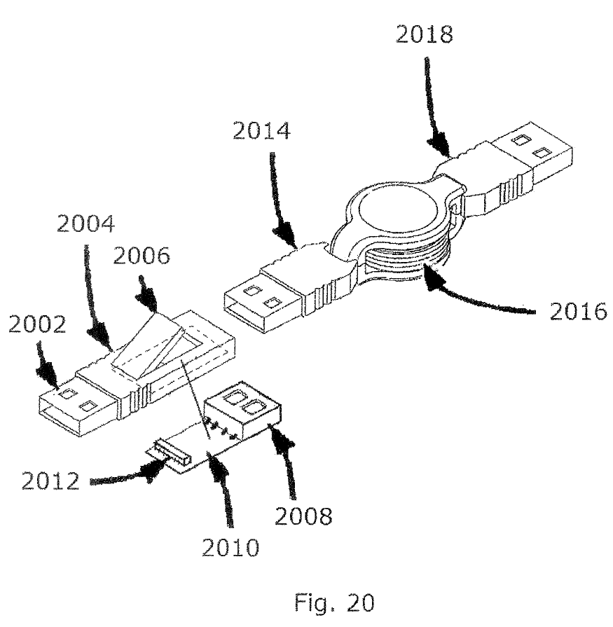

FIG. 20 shows a retrofit intelligent connector (IC) in relation to a legacy data cable with retractable cable mechanism. The embedded connector 2008 coupled to the controller PCB 2010 is contained inside the connector housing 2004 and allows the legacy cable connector 2014 to connect to the intelligent controller. In the present example, the data cable includes a coiled high-speed data cable housed in retractable cable mechanism 2016.

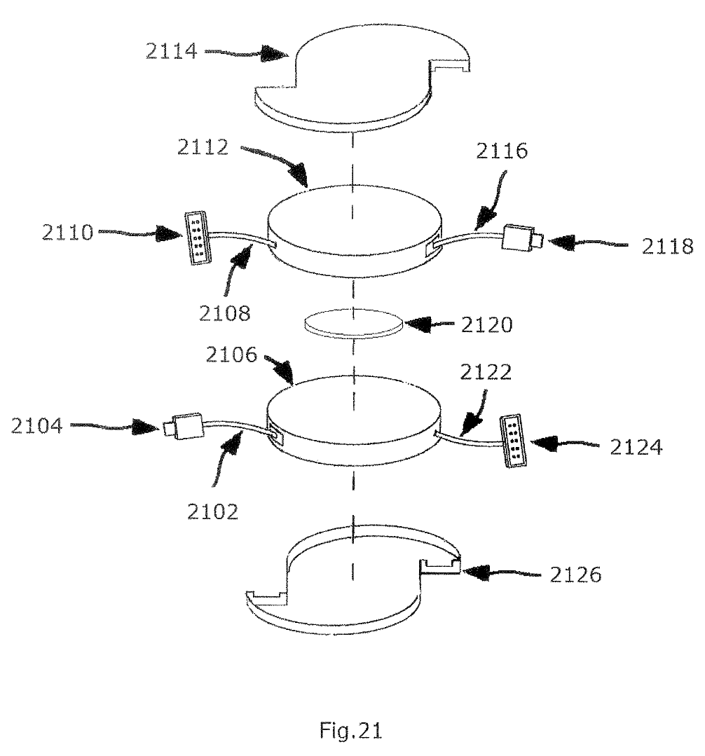

FIG. 21 is an explode view of a static universal host-to-host intelligent controller with two independent interface cables and retractable cable mechanisms in accordance with the present invention. In this embodiment, two retractable cable mechanisms 2112, 2106 are enclosed in the same retractable cable housing comprised of an upper half 2114 and lower half 2126.

The first retractable cable mechanism, 2106 is coupled to a first high-speed data cable 2102 with a high-speed data connector 2104 as well as a first static high-speed data cable 2122 with a static high-speed data cable PCB connector 2124.

Likewise, the second retractable cable mechanism 2112 is coupled to a second static high-speed data cable 2108 with a static high-speed data cable PCB connector 2110 as well as a second high-speed data cable 2116 with a high-speed data connector 2118.

Located between the retractable cable mechanisms 2112, 2106 is the static universal host-to-host intelligent controller with removable memory 2120. As with the other embodiments of the present invention, the removable memory is optional.

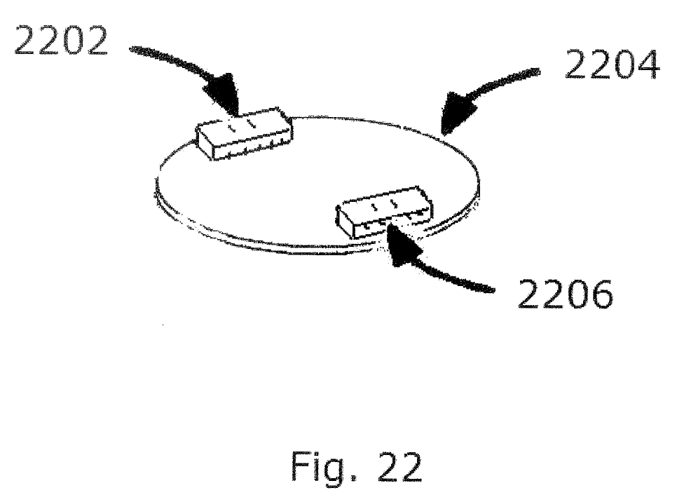

FIG. 22 shows a static universal host-to-host intelligent controller in accordance with an alternate embodiment of the present invention. Similar to the embodiments shown in FIGS. 18-20, this embodiment provides retrofit capability for legacy static high-speed data cables. This embodiment is comprised very simply of a static universal host-to-host intelligent controller PCB 2204 with removable memory and first and second static high-speed data cable PCB connectors 2202, 2206.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

We claim:

1. A universal host-to-host intelligent controller for direct data transfer between two electronic data processing (EDP) devices, the controller comprising:
(a) a printed circuit board (PCB), wherein the PCB contains drivers and software code that automatically load and execute on said EDP devices when the PCB is connected to the EDP devices, wherein said drivers and software code facilitate the direct transfer of data from storage on one EDP device to storage on the other EDP device; and
(b) at least two EDP connectors coupled to said PCB.

2. The controller according to claim 1, wherein at least one of said EDP connectors comprises a high-speed data cable coupled to a cable connector.

3. The controller according to claim 1, wherein at least one of said EDP connectors comprises a static cable PCB connector.

4. The controller according to claim 1, wherein at least one of said EDP connectors comprises an omni-directional radio frequency antenna.

5. The controller according to claim 4, further comprising a low-loss radio frequency coaxial transmission line that couples the antenna to the PCB.

6. The controller according to claim 1, wherein the PCB is contained in a housing that further comprises at least one cable retractor mechanism.

7. The controller according to claim 1, wherein the controller is incorporated into one of the EDP devices.

8. The controller according to claim 7, wherein the controller is removable from the EDP device.

9. The controller according to claim 1, wherein the PCB is contained in a molded, plug-type housing, wherein one of said EDP connectors is a high-speed data connector molded into the plug-type housing.

10. The controller according to claim 9, wherein the second of said EDP connectors is a plug port incorporated into the housing.

11. The controller according to claim 1, wherein the controller further comprises an expansion memory slot coupled to the PCB.

12. The controller according to claim 1, wherein the PCB is contained in a housing that further comprises a docking port for connection to a host EDP device docking connector.

13. The controller according to claim 12, wherein the housing further comprises a connector release lever.

14. A method for transferring data between storage on a first electronic data processing (EDP) device and storage on a second EDP device via a universal host-to-host intelligent controller, the method comprising:
(a) connecting the controller to a data bus of a first EDP device;
(b) allowing a controller file transfer utility (FTU) software executable to autorun and autoload on the first EDP device;
(c) launching said controller FTU software executable on the first EDP device and displaying storage contents of the first EDP device on a file transfer utility;
(d) repeating steps (a) through (c) for the second EDP device;
(e) sending the first EDP device a confirmation that the second EDP device is successfully connected and that both first EDP device and second EDP device are networked; and
(f) transferring data between storage on the first EDP device and storage on the second EDP device using respective FTUs on said devices.

15. The method according to claim 14, wherein step (a) further comprises:
determining an amount of current drawn by the controller when it is connected to the EDP device data bus; and
assigning a maximum bus speed to the controller based on said amount of current draw.

16. The method according to claim 14, wherein step (b) further comprises the EDP device reading product information from a memory in the controller.

17. The method according to claim 14, further comprising displaying the storage contents of both EDP devices on the FTU of each EDP device.
